(19) United States
(12) Patent Application Publication
(10) Pub. No.: US 2026/0333014 A1
(43) Pub. Date: Oct. 22, 2026

(54) Cellular Onboarding Using a Communication Connection or QR Code

(71) Applicant: Apple Inc., Cupertino, CA (US)

(72) Inventors: Raj S CHAUGULE, Santa Clara, CA (US); Li LI, Saratoga, CA (US); Lukas M BUGLA, Fremont, CA (US); Patrick L COFFMAN, San Francisco, CA (US); Sydney SUA, Alameda, CA (US)

(21) Appl. No.: 19/108,875

(22) PCT Filed: Sep. 6, 2023
(86) PCT No.: PCT/US2023/032083

§ 371 Date: Mar. 5, 2025

Related U.S. Application Data
(60) Provisional application No. 63/374,639, filed on Sep. 6, 2022.

(51) Int. Cl. H04W 8/18; G06K 19/06; H04W 8/20

(52) U.S. Cl. CPC H04W 8/183; G06K 19/06037; H04W 8/205

(57) ABSTRACT

A user equipment (UE) configured to receive, via user input, a selection of one of a plurality of connections or a QR code to activate a user equipment (UE), wherein the plurality of connections comprise a Wi-Fi connection or a bootstrap connection to a further device and activate the UE using the selected one of the connections or QR code.

### PRIORITY/INCORPORATION BY REFERENCE

This application claims priority to U.S. Provisional Application Serial No. 63/374,639 filed on Sep. 6, 2022 and entitled “Cellular Onboarding,” the entirety of which is incorporated by reference herein.

### BACKGROUND

When a user purchases a new user equipment (UE), the UE needs to be setup to operate on a cellular network. The cellular setup may include various operations including activation, install, transfer and provisioning. There may be various manners to perform this setup depending on the type of UE, the identity of the user, the type of cellular service being provided, other UEs owned/used by the user, etc. These multiple manners of performing the setup process may lead to a poor user experience in setting up their new device. Thus, there is a need to provide the user with a simple manner of setting up the UE with cellular services.

### SUMMARY

Some exemplary embodiments are related to an apparatus of a user equipment (UE), the apparatus having processing circuitry configured to receive, via user input, a selection of one of a plurality of connections or a QR code to activate a user equipment (UE), wherein the plurality of connections comprise a Wi-Fi connection or a bootstrap connection to a further device and activate the UE using the selected one of the connections or QR code.

Oexemplary embodiments are related to a processor of a user equipment (UE) having processing circuitry configured to receive, via user input, a selection of one of a plurality of connections or a QR code to activate a user equipment (UE), wherein the plurality of connections comprise a Wi-Fi connection or a bootstrap connection to a further device and activate the UE using the selected one of the connections or QR code.

### BRIEF DESCRIPTION OF THE DRAWINGS

FIG. 1 shows an exemplary network arrangement according to various exemplary embodiments.

FIG. 2 shows an exemplary UE according to various exemplary embodiments.

FIG. 3 shows an exemplary method for activating a user equipment (UE) according to various exemplary embodiments.

FIG. 4 shows exemplary display panes and an exemplary display pane order for activating a UE using a bootstrap connection according to various exemplary embodiments.

FIG. 5 shows exemplary display panes and an exemplary display pane order for activating a managed UE or store demo unit UE using a bootstrap connection according to various exemplary embodiments.

FIG. 6 shows an exemplary method for transferring a phone number to a UE after the UE has been activated according to various exemplary embodiments.

FIG. 7 shows exemplary display panes and an exemplary display pane order for an eSIM on-device activation (eSIM ODA) flow according to various exemplary embodiments.

FIG. 8 shows exemplary display panes and an exemplary display pane order for an eSIM discovery server activation flow according to various exemplary embodiments.

FIG. 9 shows exemplary display panes and an exemplary display pane order for a phone number transfer using a device to device pairing according to various exemplary embodiments.

FIG. 10 shows exemplary display panes and an exemplary display pane order for a SMS ODA (SODA) carrier tethered flow using a bootstrap connection according to various exemplary embodiments.

FIG. 11 shows an exemplary method for evaluating the display of intermediate display panes according to various exemplary embodiments.

FIG. 12 shows exemplary display panes and an exemplary display pane order for cellular setup of a UE using a short range communication connection with a source device according to various exemplary embodiments.

FIG. 13 shows exemplary display panes and an exemplary display pane order for cellular setup of a UE using a QR code according to various exemplary embodiments.

FIG. 14 shows an exemplary method for a cellular setup of a UE over a Wi-Fi connection according to various exemplary embodiments.

FIG. 15 shows exemplary display panes and an exemplary display pane order for cellular setup of a UE using a Wi-Fi connection and a backbone service according to various exemplary embodiments.

FIG. 16 shows exemplary display panes and an exemplary display pane order for cellular setup of a UE using a Wi-Fi connection and carrier information that is tethered to the UE according to various exemplary embodiments.

### DETAILED DESCRIPTION

The exemplary embodiments may be further understood with reference to the following description and the related appended drawings, wherein like elements are provided with the same reference numerals. The exemplary embodiments relate to the activation and setup of an embedded subscriber identification module (eSIM) of a user equipment (UE) to provide cellular services.

The exemplary embodiments are described with regard to a UE. However, reference to the term UE is merely provided for illustrative purposes. The exemplary embodiments may be utilized with any electronic component that is configured with the hardware, software, and/or firmware to exchange information (e. g., control information) and/or data with the network. Therefore, the UE as described herein is used to represent any suitable electronic device.

The exemplary embodiments are described with reference to setting up cellular services or cellular onboarding. As described above, cellular onboarding may include various operations including device activation, install, transfer and provisioning. However, it should be understood that the exemplary embodiments do not require all of these operations and that there may also be other operations related to cellular onboarding that may be performed when implementing the exemplary embodiments.

The exemplary embodiments are also described with regard to a bootstrap connection. A bootstrap connection may be a cellular connection over which a UE that has not yet been setup with cellular services may communicate with a cellular network of a particular cellular provider. For example, a user may purchase a new UE from a cellular provider. The UE may have an embedded subscriber identification module (eSIM) that has credentials to temporarily access cellular services for the cellular provider. This temporary connection may be used to perform some or all of the operations for the cellular onboarding. In one example, the manufacturer of the UE may own the credentials to allow the temporary cellular connection for the purposes of cellular onboarding. Thus, the bootstrap connection may be considered to be a cellular connection that may be used on a temporary basis to setup the UE with cellular services. It should be understood that the above example of the manufacturer of the UE being the owner of the credentials for the cellular connections is only exemplary and there may be other ownership arrangements for these temporary use cellular connections.

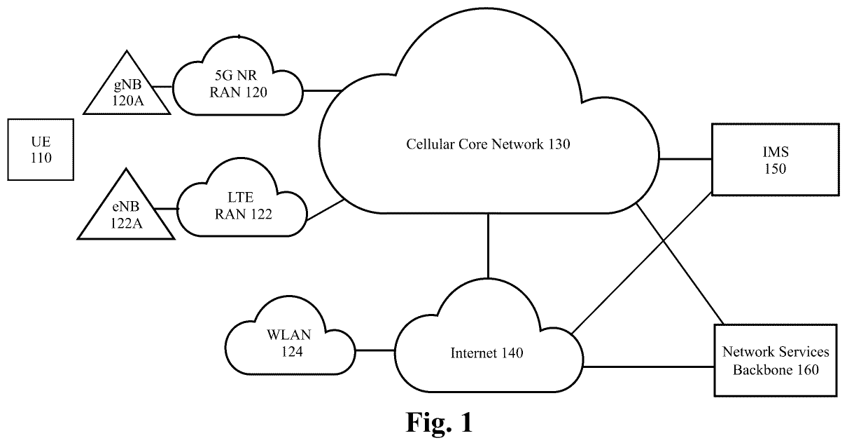

The exemplary embodiments are also described with regard to a UE that may initially be considered to be a new UE that is not yet setup with cellular services. It should also be understood that the UE is not required to be “new.” For example, the UE may be a refurbished UE that is new for the particular user. In another example, the UE may be a UE that the user previously owned but the SIM or eSIM is new to the UE. This disclosure is generally directed at the process of the UE being setup with cellular services. However, for completeness, the description below with respect to the network arrangement 100 of FIG. 1 describes the UE 110 as configured to communicate with one or more networks. It should be understood that some of this communication is performed after the UE 110 is provisioned, e.g., with cellular services.

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network arrangement 100, the network with which the UE 110 may wirelessly communicate is a fifth generation (5G) new radio (NR) radio access network (RAN) 120, a long-term evolution (LTE) RAN 122 and a wireless local area network (WLAN) 124. However, the UE 110 may also communicate with other types of networks (e.g., 5G cloud RAN, a next generation RAN (NG-RAN), a legacy cellular network, etc.) and the UE 110 may also communicate with networks over a wired connection. Therefore, the UE 110 may have a 5G NR chipset to communicate with the NR RAN 120, an LTE chipset to communicate with the LTE RAN 122 and an ISM chipset to communicate with the WLAN 124.

The 5G NR-RAN 120 and the LTE-RAN 122 may be portions of cellular networks that may be deployed by cellular providers (e.g., Verizon, AT&T, T-Mobile, etc.). These networks 120, 122 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set. The WLAN 124 may include any type of wireless local area network (Wi-Fi, Hot Spot, IEEE 802.11x networks, etc.).

Those skilled in the art will understand that any association procedure may be performed for the UE 110 to connect to the 5G NR-RAN 120 or the LTE-RAN 122. For example, as discussed above, the 5G NR-RAN 120 may be associated with a particular cellular provider where the UE 110 and/or the user thereof has a contract and credential information (e.g., stored on a SIM card). Upon detecting the presence of the 5G NR-RAN 120, the UE 110 may transmit the corresponding credential information to associate with the 5G NR-RAN 120. More specifically, the UE 110 may associate with a specific cell or base station (e. g., gNB 120A). For access to LTE services, a similar association procedure may be performed with the LTE RAN 122 via a specific cell or base station (e.g., eNB 122A). However, as mentioned above, reference to the 5G NR-RAN 120 and the LTE-RAN 122 is merely for illustrative purposes, the exemplary embodiments may apply to any type of RAN.

The network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. It may include the evolved packet core (EPC) and/or the fifth generation core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

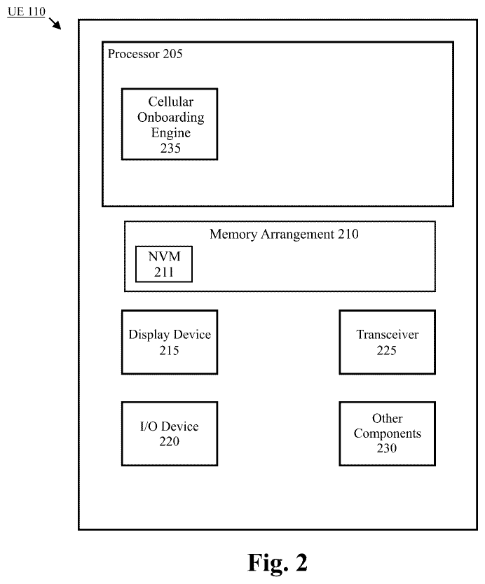

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, a camera or other optical scanning component, etc.

The processor 205 may be configured to execute a plurality of engines of the UE 110. For example, the engines may include a cellular onboarding engine 235 that may perform various operations related to the setup of cellular service for the UE 110. These operations may include displaying setup connection options to a user, interacting with other devices and network components to perform the cellular setup, determining display panes to be shown to the user during the cellular setup, etc. Each of these operations and other operations are described in greater detail below.

The above referenced engine 235 being applications (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The memory arrangement 210 may include non-volatile memory (NVM) 211 that enables the UE 110 to retain stored data after power has been switched off. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G NR-RAN 120, the LTE-RAN 122, a legacy RAN (not pictured), the WLAN 124, etc. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

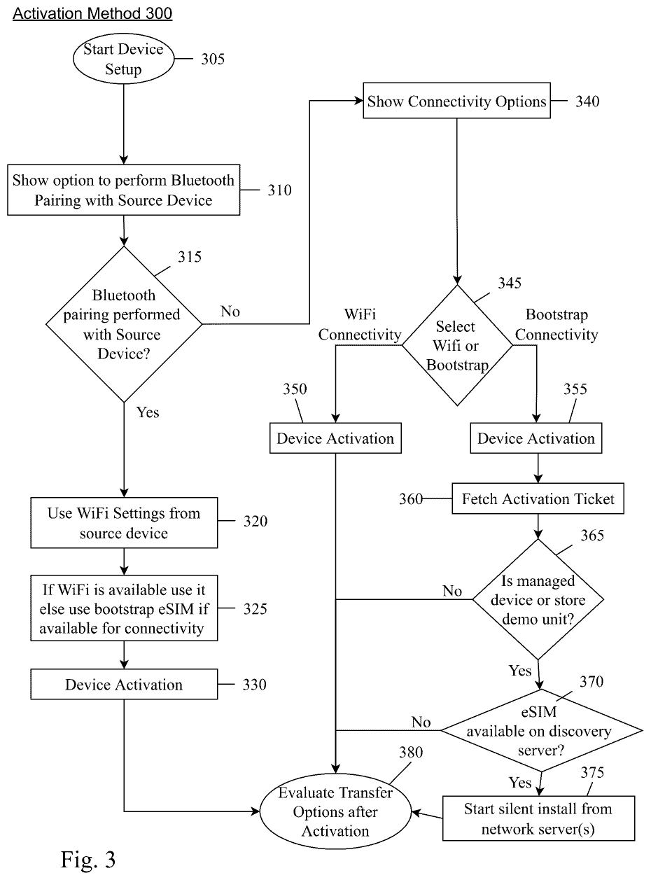

FIG. 3 shows an exemplary method 300 for activating a user equipment (UE) 110 according to various exemplary embodiments. In the description of FIG. 3, it will be described that the UE 110 will be activated in 330, 350 or 355. Those skilled in the art will understand the operations performed between the UE 110 and the cellular network to perform the device activation of 330, 350 or 355. These operations are outside the scope of the exemplary embodiments as different cellular networks may have different device activation schemes and the exemplary embodiments may be implemented with any device activation scheme. The flow of the method 300 is meant to describe information/selections that may be presented to the user during the device activation operations and the connection that is used to perform the device activation.

As described above, it may be considered that at the beginning of the method 300, the UE 110 has not yet been activated, e.g., the UE 110 is new. Thus, in 305 the user may start the device setup by, for example, powering on the UE 110. In 310, the UE 110 may present the user with a choice of connecting with a source device using Bluetooth (or any other short range communication connection). In this example, the source device may be considered to be any other device of the user. In a first example, the UE 110 may be a wearable device and the source device may be a mobile phone of the user. In a second example, the UE 110 may be a new mobile phone and the source device may be an older mobile phone of the user. In a third example, the UE 110 may be a new mobile phone and the source device may be a tablet of the user. From these examples, it should be understood that the source device may be any other device of the user that is capable of establishing the short range communication connection with the UE 110.

In 315, it is determined whether the user has selected to connect the UE 110 to the source device. If the user has selected to connect to the source device, in 320, the UE 110 may retrieve the Wi-Fi settings of the source device for use in the setup process. In 325, the UE 110 may use the Wi-Fi settings to access a Wi-Fi network (e.g., WLAN 124) to activate the UE 110 in 330. In another alternative, if the UE 110 is unable to access a Wi-Fi network associated with the Wi-Fi settings of the source device and the UE 110 has an eSIM that is capable of establishing the bootstrap connection, the UE 110 may perform the device activation in 330 using the bootstrap connection.

If, in 315, it is determined the user did not select to connect to the source device, in 340, the user may be presented with the connectivity options for the device activation. In this example, it may be considered that there are two options, a Wi-Fi connection option (based on there being one or more available Wi-Fi networks with which the UE 110 may connect) and the bootstrap connection option, e.g., the UE 110 has an eSIM that is capable of establishing the bootstrap connection. In 345, the user selects either the Wi-Fi connection option or the bootstrap connection option.

If the user selects the Wi-Fi connection option, in 350 the device activation operations are performed using the selected Wi-Fi connection. If the user selects the bootstrap connection option, in 355 the device activation operations are performed using the bootstrap connection. However, when using the bootstrap connection, in addition to the device activation operations, further operations may also be performed. These further operations may include fetching the device activation ticket in 360. The device activation ticket may include various information about the UE 110 such as the information described below with regards to 365 and 370. It should be understood that different entities may refer to a device activation ticket using different terminology but in general it is meant to refer to a set of policies that are applicable to the UE 110. The device activation ticket may, for example, be downloaded to the UE 110 from a server that is owned by the manufacturer of the UE. For example, a carrier subsidy locked device, a store demo unit or enterprise managed device may have their specific policy information in the device activation ticket.

In 365, it is determined if the UE 110 is a managed device or a store demo unit based on the information provided in the device activation ticket. A managed device may be, for example, a device that is provided to employees of an organization, e.g., private company, government agency, etc. The organization may have predefined setups for the managed devices. These predefined setups may be uniform across the organization, may be linked to job titles or locations, etc. Similarly, a store demo unit may be a device that is advertised and sold with a specific predefined setup. The device activation ticket may indicate that the UE 110 was purchased as a store demo unit with the predefined setup.

If the device activation ticket does not indicate the UE 110 is a managed device or a store demo unit, the method proceeds to 380 that will be described in greater detail below. However, if the UE 110 is a managed device or a store demo unit, the UE 110 will then determine in 370 whether the eSIM information (e. g., the predefined setups) are available on a discovery server based on the information provided in the device activation ticket. In general, a carrier may create a tether for an eSIM against a device in a discovery server (as will be described in greater detail below there are multiple types of tethers). The device checks with the discovery server and, if there is a tether for the device, the device discovers this tether that has details of where the UE may retrieve the eSIM corresponding to the device. The retrieved eSIM then allows the UE 110 to establish a cellular connection over which the UE 110 may then retrieve the predefined setup corresponding to the UE 110. The predefined setup is not generally included in the discovery server but is rather included in one or more other network servers that may correspond to the entity for the managed device, correspond to the store demo unit, etc. If the corresponding discovery server is available (e.g., if the UE 110 can connect to the correct discovery server to retrieve the eSIM), in 375, the UE 110 will use the cellular connection that may be established using the eSIM to contact the network server(s) to silently install the predefined setup. A silent install refers to an action taken by the UE 110 without further input from the user, e.g., since the setup is predefined, the user does not need to answer further questions or make further selections for the setup. If the discovery server is not available in 370, the method will continue to 380.

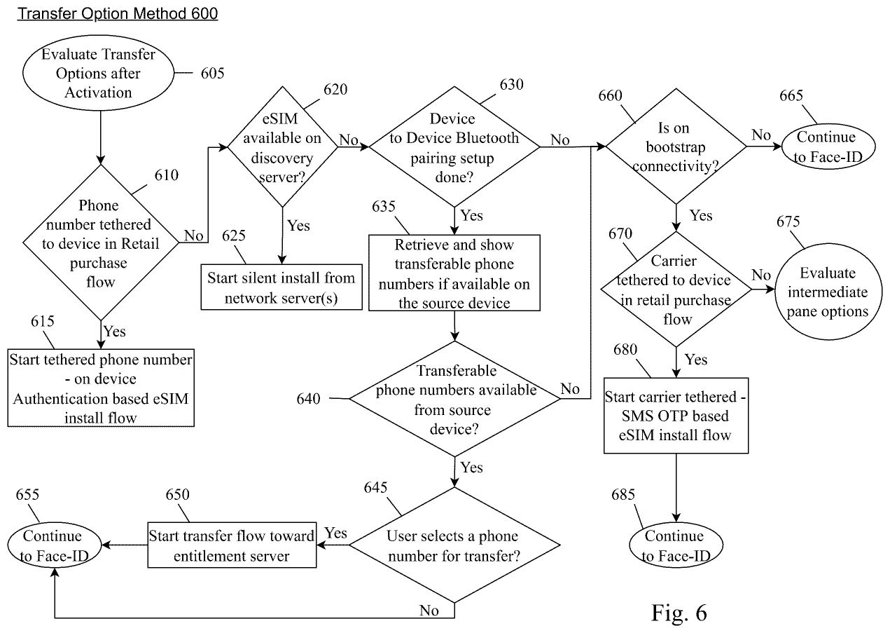

Thus, at the end of the method 300, the UE 110 will be activated and, in some instances, will have a predefined setup installed. In all cases, (e.g., source device pairing connection, Wi-Fi connection or bootstrap connection) the method proceeds to evaluate transfer options 380 that will be described in greater detail below with respect to FIG. 6. However, prior to describing the transfer options, the following figures will provide examples of display panes and the order of the presentation of the display panes that may be displayed to the user on the display of the UE 110 during the activation method 300.

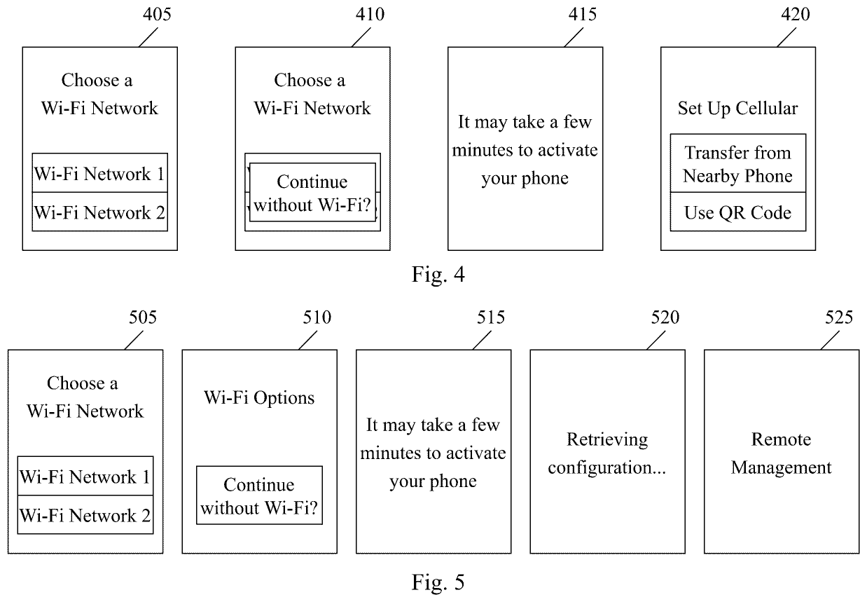

FIG. 4 shows exemplary display panes 405-420 and an exemplary display pane order for activating a UE using a bootstrap connection according to various exemplary embodiments. As described above, the bootstrap connection may be established during the source device pairing operations (e.g., 325) or during the bootstrap connectivity operations 355-375. Thus, the display panes 405-420 may be displayed during any of these operations.

The display pane 405 shows the user being provided with an option to select an available Wi-Fi network for the device activation. The display pane 410 shows the user selecting to use the bootstrap connectivity process instead of the Wi-Fi connection, e.g., the user has selected to continue without using Wi-Fi. The display pane 415 shows the UE 110 displaying a message to the user while the bootstrap connection is established and while the operations related to the activation are occurring. The display pane 420 shows the UE 110 indicating to the user that the activation is complete because the user is given options to setup the cellular service for the UE 110, e.g., the display pane 420 corresponds to the evaluate transfer options 380 of the method 300. As stated above, the setting up of the cellular service will be described in greater detail below.

FIG. 5 shows exemplary display panes 505-525 and an exemplary display pane order for activating a managed UE or store demo unit UE using a bootstrap connection according to various exemplary embodiments. As described above, the UE 110 may be a managed device or a store demo unit and the bootstrap connectivity flow may correspond to the operations 355-375 to activate and silently install the correct predefined setup.

The display panes 505-515 are similar to the display panes 405-415 are not described again. The display pane 520 shows the UE 110 displaying a message to the user while the UE 110 contacts the corresponding discovery server and silently installs the predefined setup (e.g., 370 of the method 300).

After the predefined setup has been installed, the display pane 525 may allow the user to select a remote management for the UE 110. For example, the remote management may allow the entity that has provided the device (e.g., the user's employer) to manage certain aspects of the UE 110, e.g., restrict certain functionality, install applications, manage backups, monitor internet traffic, manage device settings, etc.

FIG. 6 shows an exemplary method 600 for transferring a phone number to a UE after the UE has been activated according to various exemplary embodiments. 605 corresponds to 380 of the method 300, e.g., after the UE 110 has been activated, the UE 110 evaluates different manners of transferring a telephone number to the UE 110.

In 610, the UE 110 evaluates whether there was a phone number tethered to the UE 110 at the time of purchase, e.g., the eSIM of the UE 110 is pre-provisioned with a phone number when the UE 110 was purchased at the retail (or other) outlet. If there is a phone number tethered to the UE 110 at the time of purchase, a eSIM on-device activation (eSIM ODA) flow may be started.

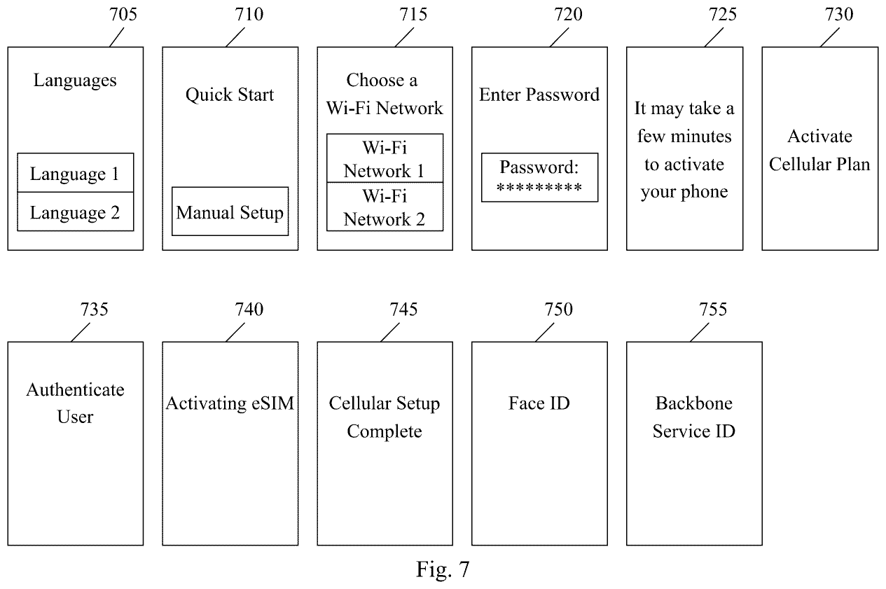

FIG. 7 shows exemplary display panes 705-755 and an exemplary display pane order for an eSIM on-device activation (eSIM ODA) flow according to various exemplary embodiments. It should be understood that the display panes 705-755 may encompass operations from both the method 300 (activation) and the method 600 (cellular setup).

The display pane 705 allows the user to select the language for the setup. The display pane 710 allows the user to quick start the setup or manually set up the UE 110. Typically, the quick start option allows a user to bring another device in physical proximity to the UE 110 to transfer settings for the setup. On the other hand, the user may select to manually set up the UE 110 during this flow.

The display pane 715 allows the user to select a Wi-Fi network for the setup while the display pane 720 allows the user to enter the password to connect to the Wi-Fi network. It should be understood that while this flow shows the user using a Wi-Fi connection for this setup, the user may also select to perform this setup using the bootstrap connection, e.g., after the display pane 715, the user may select the bootstrap connection similar to display panes 410 and 510.

The display pane 725 shows the UE 110 displaying a message to the user while the UE 110 activates the UE 110. The device activation was described above with reference to, for example, operations 330, 350 and 355 of method 300.

After the device activation, the display pane 730 may provide the user with information regarding the cellular connection and the option to activate the phone number that is tethered to the UE 110. For example, the display pane 730 may display the number tethered to the UE 110 so the user may verify it is the correct phone number that the user received when purchasing the UE 110. In this example, it may be considered that the information is correct and the user selects to continue with the activation. However, it should be pointed out that during the example flows that are described herein (e. g., FIGS. 4, 5, 7, 8, 9, 10, 12, 13, 15, 16), there may be various points where the user can abort the flow and select to continue with the setup at a later time or inform the network provider, device manufacturer, retail outlet, etc. that there is an issue with the UE 110.

The display pane 735 allows the user to be authenticated by the network provider. For example, the user may enter their zip code (or any other identification information) that was provided by the user at the time of purchase (or other time) so that the phone number and corresponding subscription for the phone number may be activated. Again, in this flow, it may be considered that the user entered the correct information, and the display pane 740 shows the UE 110 displaying a message to the user while the UE 110 activates the cellular service using the phone number tethered to the UE 110. Those skilled in the art will understand that the UE 110 and the cellular network may perform various operations and exchange various messages to activate the phone number tethered to the UE 110. These operations and messages may be different depending on the particular network provider. The operations and messages are outside the scope of this disclosure because the exemplary embodiments may be used with any manner of activating the phone number tethered to the UE 110.

The display pane 745 indicates to the user that the cellular setup was successful and the cellular service for the phone number is now active. The display panes 750 and 755 may then continue the setup of the device by the user. For example, the display pane 750 may prompt the user to setup restricted access to the device, e.g., using a face ID (or other biometric method such as fingerprint or retinal information), using pass codes, etc. The display pane 755 may be used to set up various network services, e.g., backup services, VPN services, etc.

Thus, this eSIM ODA flow may be considered to be a front loaded flow that does not depend on the connectivity of the UE for performing the cellular setup, e.g., the flow may be performed using the Wi-Fi connection and/or the bootstrap connection.

Returning to the method 600 of FIG. 6, if in 610 it is determined that there is no phone number tethered to the UE 110, in 620, it is determined if there is a eSIM setup available on a discovery server for the UE 110. The process of determining whether there is an eSIM available on a discovery server was described above with reference to 360-370 of method 300. If this discovery server information is available, in 625, the UE 110 will silently the eSIM from the discovery server. The user may then manually setup the UE 110 using the cellular connection associated with the eSIM.

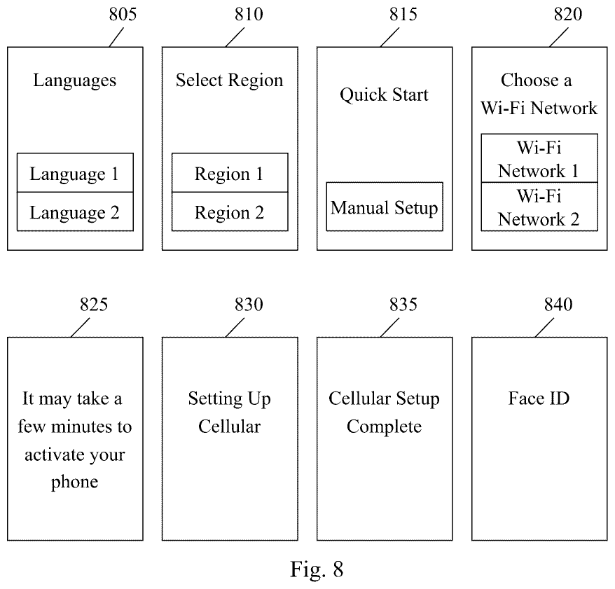

FIG. 8 shows exemplary display panes 805-840 and an exemplary display pane order for an eSIM discovery server activation flow according to various exemplary embodiments. Again, it should be understood that the display panes 805-840 may encompass operations from both the method 300 (activation) and the method 600 (cellular setup).

The display pane 805 allows the user to select the language for the setup. The display pane 810 allows the user to select a region for the setup. The display pane 815 allows the user to quick start the setup or manually set up the UE 110 similar to the display pane 710 described above. The display pane 820 allows the user to select a Wi-Fi network for the setup. Again, it should be understood that while this flow shows the user using a Wi-Fi connection for this setup, the user may also select to perform this setup using the bootstrap connection, e.g., after the display pane 820, the user may select the bootstrap connection similar to display panes 410 and 510.

The display pane 825 shows the UE 110 displaying a message to the user while the UE 110 activates the cellular service and the display pane 830 shows the UE 110 displaying a message to the user while the UE 110 sets up the cellular service using the information from the discovery server.

The display pane 835 indicates to the user that the cellular setup was successful and the cellular service for the phone number is now active. The display pane 840 may then continue the setup of the device by the user, e.g., using a face ID (or other biometric method such as fingerprint or retinal information), using pass codes, etc.

Similar to the eSIM ODA flow, the eSIM discovery server flow may be considered to be a front loaded flow that does not depend on the connectivity of the UE for performing the cellular setup, e.g., the flow may be performed using the Wi-Fi connection and/or the bootstrap connection. In addition, because the UE 110 is a managed device or a store demo unit, the user will have provided consent for the predefined setup. Thus, the silent install can be used because no user consent is required during the install and setup.

Returning to the method 600 of FIG. 6, if in 620 it is determined that there is no discovery server available for the eSIM setup, in 630, it is determined if the user has decided to pair the UE 110 with a source device as was described above with reference to 310 of method 300. If the UE 110 is paired with a source device, in 635, the UE 110 retrieves and displays phone numbers from the source device that may be transferred to the UE 110 during the cellular setup. In 640, it is determined if there are any available numbers for transfer. If there are no phone numbers available for transfer, the method continues to 660 which will be described in greater detail below.

If there are phone numbers available for transfer, in 645, the user is provided with an option to select one of the phone numbers for the transfer. If the user selects one of the phone numbers, in 650, a transfer flow is initiated with an entitlement server to transfer the phone number from the source device to the UE 110. If the user does not want to transfer one of the available phone numbers from the source device in 645 or after the transfer flow is complete in 650, the method 600 may then continue the setup of the device by the user, e.g., face ID Setup 655.

Thus, at the end of this flow, the UE 110 may have the cellular number setup based on selecting one of the transferable phone numbers from the source device or the UE may not have the cellular setup if the user did not want to use one of the transferable numbers.

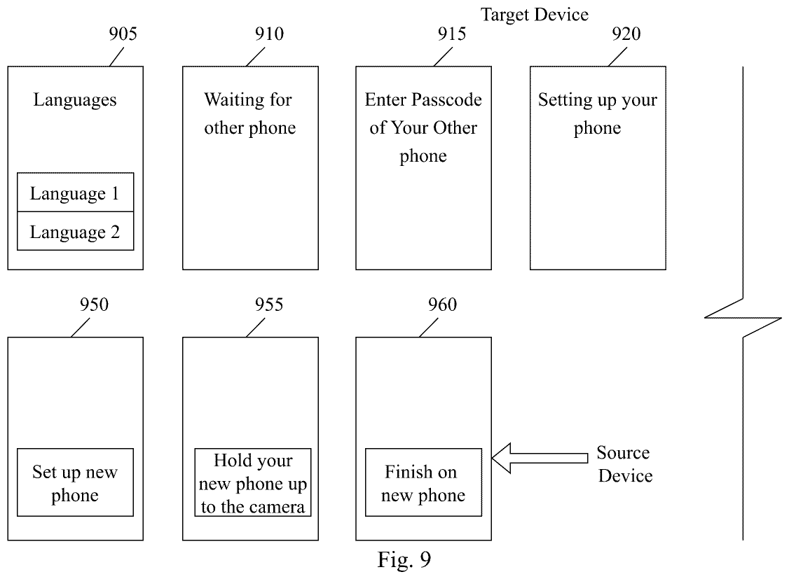

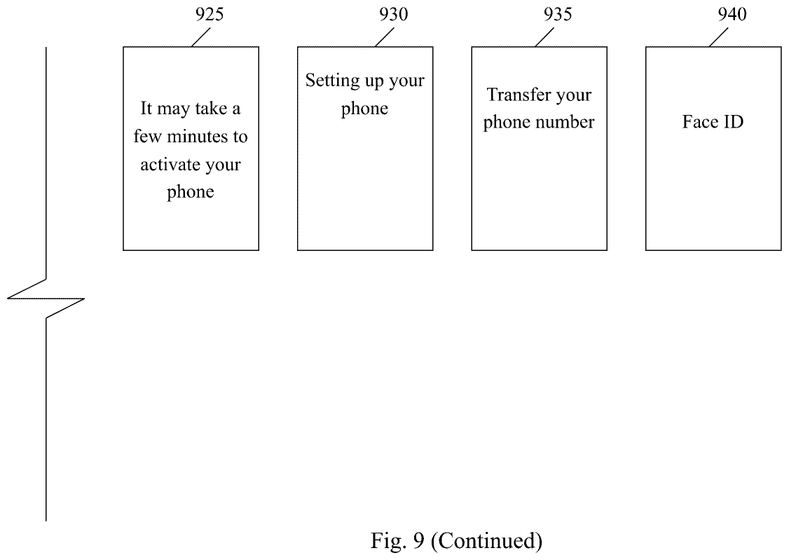

FIG. 9 shows exemplary display panes 905-960 and an exemplary display pane order for a phone number transfer using a device to device pairing according to various exemplary embodiments. Again, it should be understood that the display panes 905-960 may encompass operations from both the method 300 (activation) and the method 600 (cellular setup). In this example, the display panes 905-935 are displayed on the UE 110 that is being setup while the display panes 950-960 are displayed on the paired source device. The device to device pairing over the short range communication connection may be used to migrate settings and other information from one device (e.g., the source device) to the new device (e.g., the UE 110). The exemplary display panes of FIG. 9 show part of this migration that includes the transfer of a phone number from the source device to the UE 110. However, it should be understood that other settings and information may also be migrated to the UE 110 as part of this device to device pairing.

The display pane 905 of the UE 110 allows the user to select the language for the setup. The display pane 950 of the source device allows the user to select to pair with the UE 110 for the purpose of setting up the new phone. As described above, the pairing may be over Bluetooth or any other short range connection. The display pane 910 shows the UE 110 displaying a message to the user while the UE 110 and the source device are being paired. The display pane 955 of the source device allows the source device to determine the identity of the new device (UE 110) that is going to be set up. In this example, it is based on an identification using the camera of the source device, e.g., the UE 110 is identified based on a visual indication of the UE 110. After the UE 110 is successfully paired with and identified by the source device, the display pane 960 of the source device may indicate to the user that all additional setup operations will be performed on UE 110.

Thus, the display pane 915 prompts the user to enter the passcode for the source device into the UE 110. The display panes 915, 920 and 925 shows the UE 110 displaying a message to the user while the UE 110 is being setup using the settings from the source device. This may include the transferring of information from the source device to the UE 110 (915), the activation (920) and the cellular setup (925).

The display pane 930 may display the option to transfer one or more phone numbers from the source device to the UE 110 corresponding to the operations 640 and/or 645 of the method 600. As described above, the user may select to transfer a phone number from the source device, which will initiate a transfer flow with an entitlement server to transfer the phone number from the source device to the UE 110. Those skilled in the art will understand that the transfer flow may involve various operations and message exchanges between the UE 110, the entitlement server and the cellular network to transfer the phone number. These operations and messages may be different depending on the particular network provider. The operations and messages are outside the scope of this disclosure because the exemplary embodiments may be used with any manner of transferring the phone number from the source device to the UE 110.

After the transfer is complete or if the user selects to wait to complete the cellular setup, the display pane 940 may then continue the setup of the device by the user, e.g., using a face ID (or other biometric method such as fingerprint or retinal information), using pass codes, etc.

Returning to the method 600, if the user has not paired the UE 110 with a source device (630) or if there are no phone numbers to transfer from the source device to the UE 110 (640), in 660, the UE 110 will determine if bootstrap connectivity is available. If the bootstrap connectivity is not available, the cellular setup will be skipped and the user may continue further setup of the device, e.g., using a face ID (or other biometric method such as fingerprint or retinal information), using pass codes, etc.

If the bootstrap connectivity is available, in 670, the UE 110 evaluates whether there was a carrier tethered to the UE 110 at the time of purchase, e. g., the eSIM of the UE 110 is pre-provisioned with a carrier when the UE 110 was purchased at the retail (or other) outlet. If there was no carrier tethered to the UE at the time of purchase, the method 600 may continue to 675 where intermediate panes are evaluated. This evaluation of intermediate panes is described in greater detail below.

If there is a carrier tethered to the UE 110 at the time of purchase, a SODA carrier tethered flow may be started. At the completion of the SODA carrier tethered flow, the user may continue further setup of the device, e.g., using a face ID (or other biometric method such as fingerprint or retinal information), using pass codes, etc.

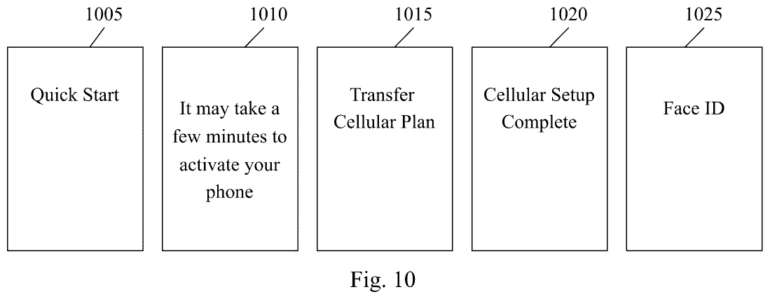

FIG. 10 shows exemplary display panes 1005-1025 and an exemplary display pane order for a SODA carrier tethered flow using a bootstrap connection according to various exemplary embodiments. FIG. 7 has already described the eSIM ODA flow for the bootstrap connection. Thus, the display panes described for FIG. 10 are an abbreviated display of the SODA panes applicable to the carrier tethered flow.

The display panes 1005 and 1010 may represent the same display panes 710 and 725 of FIG. 7 and the various other display panes previous to display pane 725 may also be displayed in the flow of FIG. 10. The display pane 1015 shows a message to the user that the user can transfer a previously purchased cellular plan to the UE 110. For example, the display pane 1015 may prompt the user to enter information about the user's account with the carrier, e. g., account number, user social security number, etc. The carrier may then send an SMS message to the source device with an authentication code that the user may enter into the UE 110 to verify that the user wants to transfer the cellular plan the user has with the carrier to the UE 110.

In this flow, it may be considered that the user has entered the correct information and the correct verification code. Thus, the UE 110 will be setup with the cellular service according to the user's cellular plan with the carrier. The display pane 1020 will be displayed to indicate to the use that the cellular setup is complete. The display pane 1025 may then continue the setup of the device by the user, e.g., using a face ID (or other biometric method such as fingerprint or retinal information), using pass codes, etc.

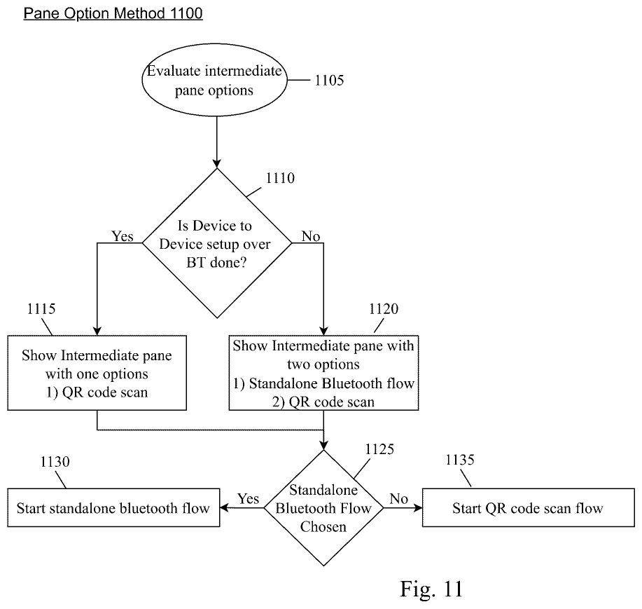

FIG. 11 shows an exemplary method 1100 for evaluating the display of intermediate display panes according to various exemplary embodiments. As described above, this evaluation may be performed when there is no carrier tethered to the UE 110 during the retail purchase (675). Thus, 1105 corresponds to 675 of the method 600. More specifically, the intermediate panes are displayed when the UE 110 has not yet been setup with the cellular service and the intermediate panes provide the user with additional options for setting up the cellular service.

In 1110, the UE 110 determines whether the device to device setup over Bluetooth has been completed. If the device to device setup has been completed, in 1115, the UE 110 will display an intermediate pane to the user with one option to use a QR code for the cellular setup, e.g., if the Bluetooth device to device setup has been completed this would mean that there are no transferable phone numbers or the user decided not to transfer a phone number. The display of the QR code will be described in greater detail below. If the device to device setup has not been completed, in 1120, the UE 110 will display an intermediate pane to the user with two options, to use a QR code or a standalone Bluetooth flow for the cellular setup.

In 1125, the UE 110 determines whether the user selected the standalone Bluetooth flow or the QR code scan flow. If the standalone Bluetooth flow was selected, in 1130, the UE 110 performs the standalone Bluetooth flow for cellular setup. This standalone Bluetooth flow will be described in greater detail below. If the standalone Bluetooth flow was not selected in 1125, in 1135, the UE 110 performs the QR code scan flow for cellular setup. This QR code scan flow will be described in greater detail below.

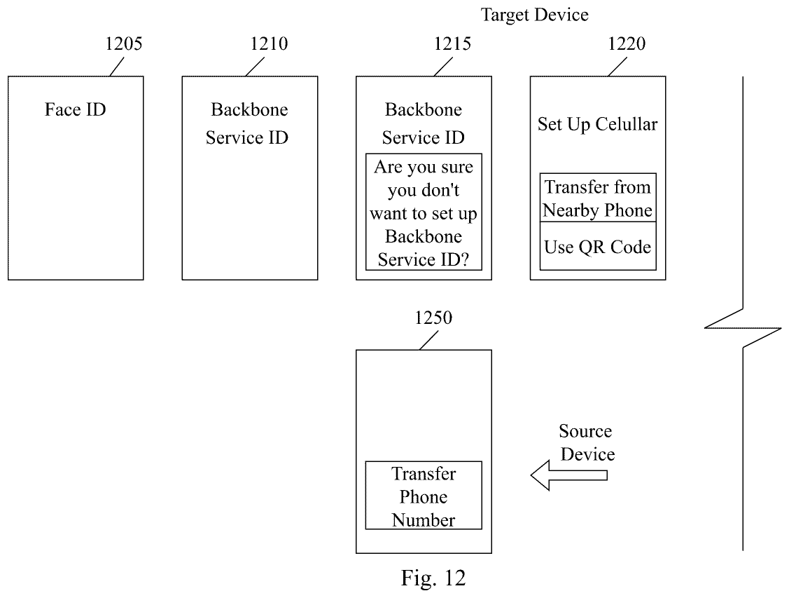

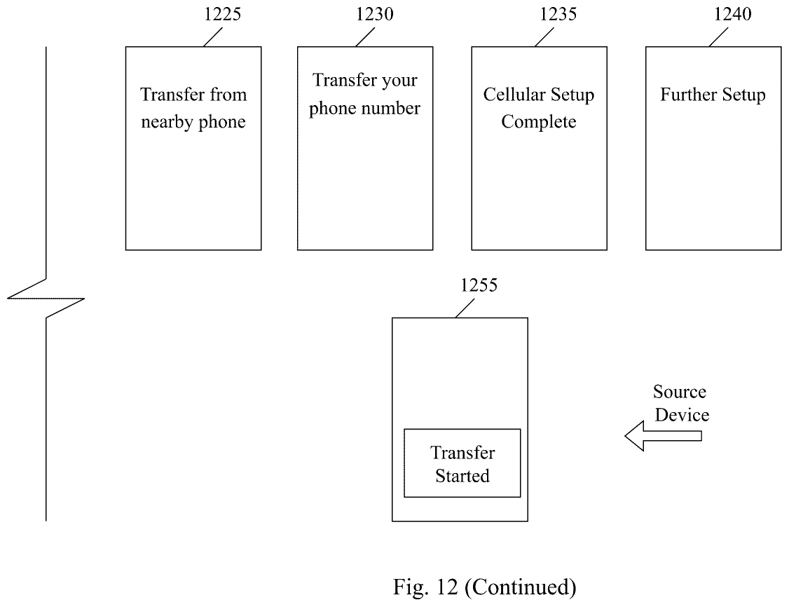

FIG. 12 shows exemplary display panes 1205-1255 and an exemplary display pane order for cellular setup of a UE using a short range communication (e.g., Bluetooth) connection with a source device according to various exemplary embodiments. The display panes 1205-1255 correspond to the standalone Bluetooth flow described above with reference to the method 1100 of FIG. 11. In addition, the display panes 1205-1240 are displayed on the UE 110, while the display panes 1250 and 1255 are displayed on the source device that is used for the standalone Bluetooth flow.

The display pane 1205 prompts the user to unlock the UE 110 for cellular setup. In this example, the unlocking is performed using the face ID that was previously setup by the user. However, any manner of unlocking the UE 110 may be used. Once the UE 110 is unlocked, the display pane 1210 prompts the user to enter an identification for one or more the backbone services, e.g., a backbone service that associates multiple devices of the user with a singular account, etc. In this example, as shown in display pane 1215 it may be considered that the user does not have or does not want to use the backbone services.

The display pane 1220 may be considered the intermediate pane that offers the user the choice of using the standalone Bluetooth flow or the QR code scan flow. In this example, it may be considered that the user has selected the standalone Bluetooth flow such that the display pane 1225 is shown that instructs the user to connect to source device for the transfer to occur. Thus, the user will connect the UE 110 with a source device over a Bluetooth or other short range communication protocol. The display pane 1250 of the source device shows that the user has selected to transfer a phone number from the source device to the UE 110.

The display pane 1230 allows the user to select the phone number from the source device to transfer. As stated above, the source device may have more than one phone number available to transfer to the UE 110. Thus, the display pane 1230 may display the one or more phone numbers and the user may select the number that the user wishes to transfer.

Once the number is selected, the UE 110 will initiate a transfer flow. As described above, the transfer flow may include contacting an entitlement server to perform the transfer. The display pane 1255 of the source device may indicate to the user that the transfer has started. The display pane 1235 will indicate to the user when the transfer is complete meaning that the cellular setup is complete. Finally, the display pane 1240 may prompt the user for further setup of the UE 110.

The flow of FIG. 9 and the flow of FIG. 12 both refer to situations where the short range communication connection (e.g., Bluetooth) is used for the transfer of a phone number to the UE 110. However, it should be understood that these flows may be mutually exclusive. As described above, the flow of FIG. 9 is used for the migration of multiple settings from the source device to the UE 110 and the phone number may be one setting among others. In contrast, the flow of FIG. 12 is directed to the process of the standalone Bluetooth flow for the transfer of the phone number from the source device to the UE 110. This mutual exclusivity is shown by example in operations 1110 and 1115 of FIG. 11 where it is stated that if the device to device setup over Bluetooth was performed, the user will not be provided with the option of the standalone Bluetooth flow for the transfer of the phone number.

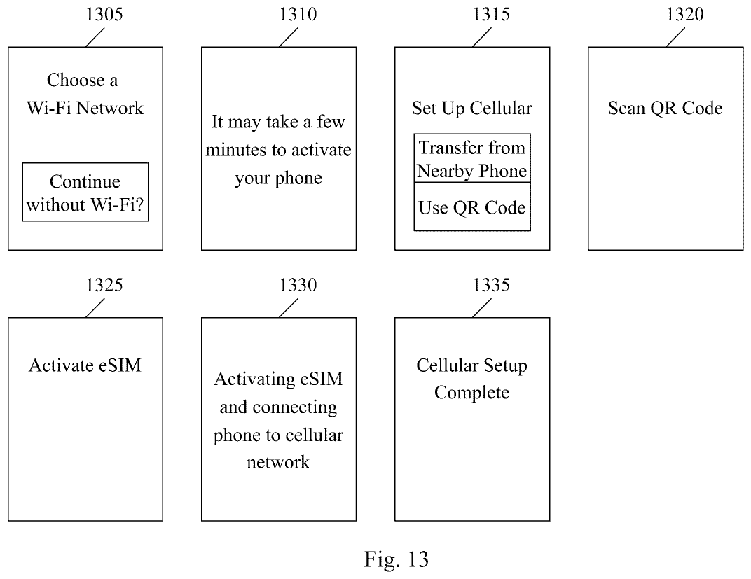

FIG. 13 shows exemplary display panes 1305-1335 and an exemplary display pane order for cellular setup of a UE using a QR code according to various exemplary embodiments. The display panes 1305 and 1310 show previously described manners of activating the UE 110. However, as described above, there may be other manners of activating the UE 110 and the cellular setup using the QR code as described herein may be used with these other manners of activating the UE 110.

The display pane 1315 may be considered the intermediate pane that offers the user the choice of using the standalone Bluetooth flow or the QR code scan flow. As described above, there may be another intermediate pane that offers the user only the choice of using the QR code scan flow. In this example, it may be considered that the user has selected the QR code scan flow such that the display pane 1320 is shown that instructs the user to scan a QR code for setup of the cellular service. The user may obtain the QR code from any number of sources, e.g., the QR code may be included on the box or on instructions accompanying the phone, there may be a URL which the user may connect using another device that displays the QR code that may then be scanned by the UE 110, etc.

The scanning of the QR code prompts the UE 110 to display the display pane 1325 requesting the user to confirm the activation of the cellular service. Assuming the user confirms the setup, the display pane 1330 will indicate to the user that the cellular setup is being performed and the display pane 1335 will indicate when the cellular setup is complete.

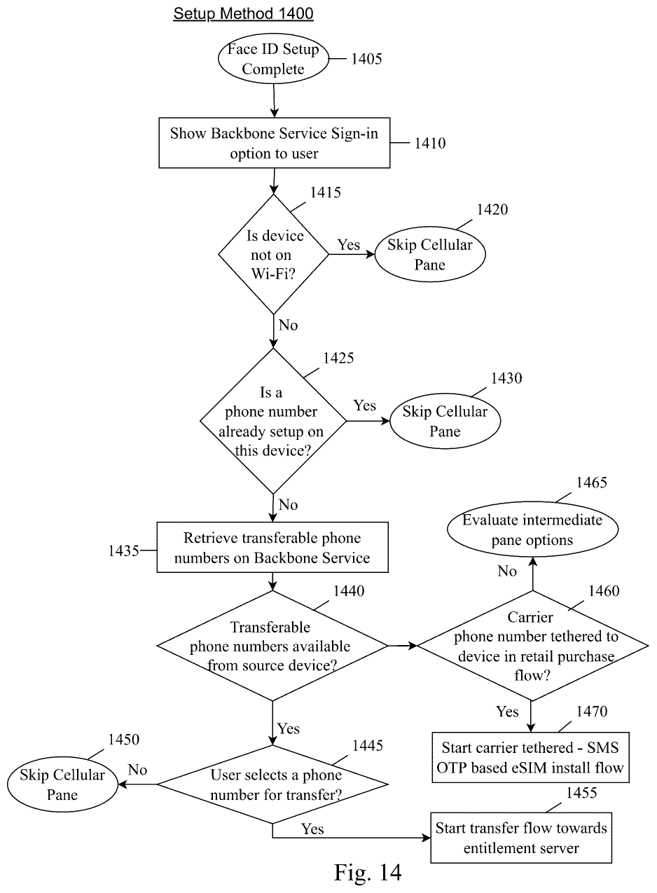

FIG. 14 shows an exemplary method 1400 for a cellular setup of a UE over a Wi-Fi connection according to various exemplary embodiments. As described above, with reference the method 600 of FIG. 6, there are various flows that lead to a user setting up a face ID or other biometric manner of unlocking the UE 110 without the cellular setup being complete. The method 1400 addresses the scenario where the face ID has been setup but the cellular setup is not complete.

Thus, in 1405, it is considered that the face ID setup is complete. In 1410, the UE 110 prompts the user to access a backbone service that associates multiple devices of the user with a singular account. In 1415, the UE 110 determines whether there is an active Wi-Fi connection. If there is no active Wi-Fi connection, the user is not prompted (1420) with a display pane to setup the cellular services, e.g., the cellular services are only setup over an active Wi-Fi connection in this flow. In 1425, the UE 110 determines whether a phone number has already been setup on the UE 110. If there a phone number has already been setup, the user is not prompted (1430) with a display pane to setup the cellular services because that process has already been completed.

In 1435, the UE 110 retrieves any transferable phone numbers from the backbone service, e.g., other devices of the user that are connected to the backbone service may upload the transferable numbers to the backbone service. In 1440, the UE 110 determines whether there any transferable numbers available from other devices of the user, e. g., did the UE 110 retrieve any transferable phone numbers in 1435.

If there are no transferable phone numbers, in 1460, the UE 110 determines if a phone number or a carrier were tethered to the UE 110 during the retail purchase. If a phone number or a carrier was tethered to the UE 110, in 1470, the eSIM ODA flow or the carrier SODA flow may be performed to setup the cellular services for the UE 110. These flows were described above and will not be described again, except to note that the ODA flows of 1470 are limited to the Wi-Fi connection rather than the also being available for the bootstrap connection. If a phone number or a carrier was not tethered to the UE 110, in 1465, the UE 110 performs the intermediate pane evaluation method of FIG. 11.

If there are transferable phone numbers in 1440, in 1445, the UE 110 determines if the user has selected one of the transferable phone numbers for the cellular setup of the UE 110. If the user does not select one of the available transfer phone numbers, the user is not prompted (1450) with a display pane to setup the cellular services. If the user selected one of the transferable phone numbers for the cellular setup of the UE 110, in 1455, a transfer flow is initiated with an entitlement server to transfer the phone number from the source device to the UE 110.

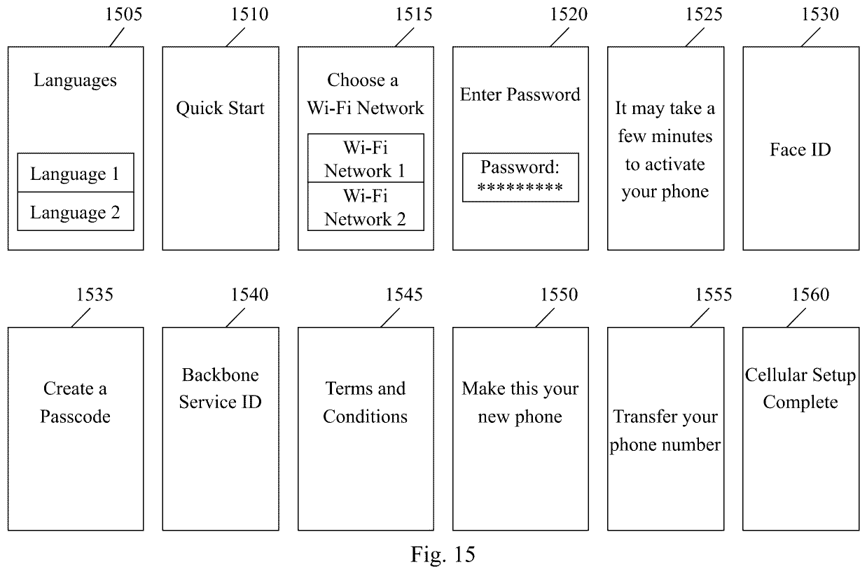

FIG. 15 shows exemplary display panes 1505-1560 and an exemplary display pane order for cellular setup of a UE using a Wi-Fi connection and a backbone service according to various exemplary embodiments. The display panes 1505-1535 for selecting a language, a manual or quick start process, selecting and signing into a Wi-Fi network, setting up a face ID and setting up a passcode have been described above and will not be described again.

The display pane 1540 prompts the user to access the backbone service that associates multiple devices of the user with a singular account. The display pane 1545 display a terms and conditions page of the backbone service that the user may accept. The display pane 1550 prompts the user to associate the UE 110 with the backbone service that will then associate the UE 110 with the user's account.

The display pane 1555 may then display the available transferable phone numbers from other devices of the user that may be transferred to the UE 110 and the user may select one of the transferable phone numbers to be used for the cellular setup of the UE 110, e.g., in 1445 of method 1400. The transfer flow may then be initiated with the entitlement server to transfer the phone number from the source device to the UE 110. The display pane 1560 will indicate to the user when the transfer is complete.

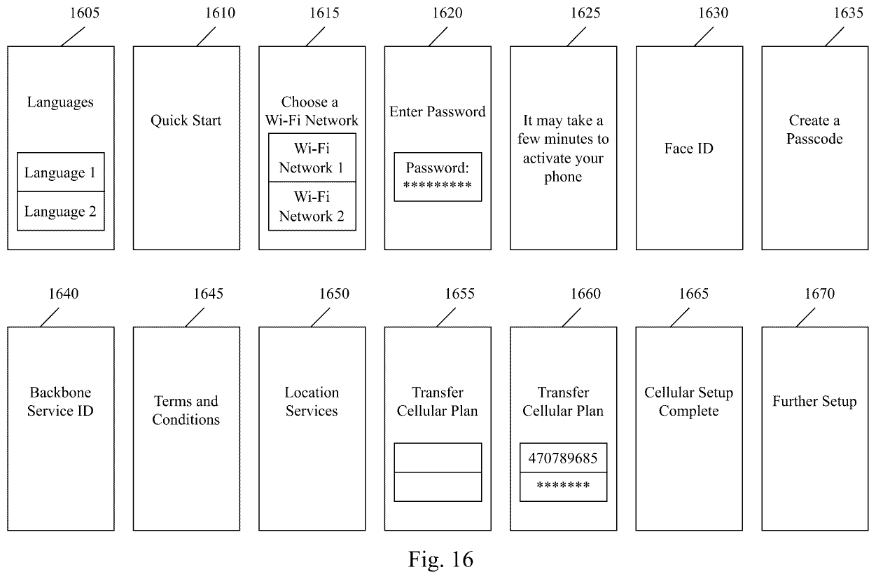

FIG. 16 shows exemplary display panes 1605-1670 and an exemplary display pane order for cellular setup of a UE using a Wi-Fi connection and carrier information that is tethered to the UE according to various exemplary embodiments. The display panes 1605-16455 for selecting a language, a manual or quick start process, selecting and signing into a Wi-Fi network, setting up a face ID, setting up a passcode, accessing the backbone service and accepting the terms and conditions of the backbone service have been described above and will not be described again. The display pane 1650 prompts the user to accept one of the services (e.g., a location service) of the backbone service, e.g., for enabling location of a lost or stolen device.

The display pane 1655 shows a message to the user that the user can transfer a previously purchased cellular plan to the UE 110. This is associated with the SODA carrier flow in 1470 of the method 1400. For example, the display pane 1660 may prompt the user to enter information about the user's account with the carrier, e.g., account number, user social security number, etc. The carrier may then send an SMS message over the bootstrap connection with an authentication code that the user may enter into the UE 110 to verify that the user wants to transfer the cellular plan the user has with the carrier to the UE 110.

In this flow, it may be considered that the user has entered the correct information and the correct verification code. Thus, the UE 110 will be setup with the cellular service according to the user's cellular plan with the carrier. The display pane 1665 will be displayed to indicate to the use that the cellular setup is complete. The display pane 1670 may then continue with a further setup of the device by the user.

As stated above, the SODA carrier flow is similar to the SODA carrier flow described with reference to FIG. 10, except that the SODA carrier flow of FIG. 16 is limited to the Wi-Fi connection rather than the also being available for the bootstrap connection.

In the above description, the various flows are shown in specific orders. However, the order of the flows may be changed or altered. To provide an example, the non-tethered flows such as the intermediate pane and SODA may be moved to after the backbone service sign in is completed. The reason for this is that the eSIM transfer flow after backbone service sign in may enhance the user experience if an eSIM on the source device is available from the backbone service and can be transferred. This may result in a simpler and fewer steps thereby enhancing the user experience.

In a further example, when a user is activating the UE over Wi-Fi and the flow has backbone service sign in near the beginning of the flow, this allows the UE to check if there are eSIMs on the backbone service. If there are none, then the other non-tethered flows may be offered to the user.

In an additional example, when setting up over the bootstrap connection, backbone service sign-in and retrieving eSIM data from the backbone service is not possible. Thus, in this example, some of the non-tethered flows may be moved forward right after activation. In this example, users may leverage the cellular connectivity for the backbone service sign-in.

From these examples it should be seen that there may be various manners of arranging the order of the flows and that the order presented in the above description is only exemplary.

### EXAMPLES

In a first example, a method comprising selecting one of a plurality of connections or a QR code to activate a user equipment (UE), wherein the plurality of connections comprise a Wi-Fi connection or a bootstrap connection and activating the UE using the selected one of the connections or QR code.

In a second example, the method of the first example, wherein, when the selected one of the connections is the bootstrap connection, the method further comprising, after activating the UE, determining the UE is a managed device or a store demo unit, accessing a discovery server based on first information determined when activating the UE and performing a setup of a cellular service for the UE based on second information retrieved from the discovery server, wherein the setting up of the cellular service is performed without any input from a user of the UE.

In a third example, the method of the first example, further comprising, after activating the UE, determining a phone number is tethered to the UE, wherein the phone number is related to a cellular service plan for a user of the UE, receiving identification information related to the cellular service plan from the user, verifying the identification information and when the identification information is verified, performing a setup of a cellular service for the UE based on the cellular service plan.

In a fourth example, the method of the first example, further comprising, after activating the UE, determining a carrier is tethered to the UE, wherein a user of the UE has a cellular service plan with the carrier, receiving identification information related to the cellular service plan from the user, verifying the identification information and, when the identification information is verified, performing a setup of a cellular service for the UE based on the cellular service plan.

In a fifth example, the method of the fourth example, wherein verifying the identification information comprises receiving a verification code entered by the user, wherein the verification code is received in a short message service (SMS) message on the source device from the carrier.

In a sixth example, the method of the first example, further comprising, after activating the UE, determining one or more options for a cellular setup of the UE, displaying the one or more options to a user of the UE, receiving a selection of the one or more options and performing a setup of a cellular service for the UE based on the selected one or more options.

In a seventh example, the method of the sixth example, wherein the selected one of the options is for the cellular setup using a QR code, and wherein performing the setup of the cellular service comprises scanning a QR code using the UE and retrieving information for the setup of the cellular service based on the QR code.

In an eighth example, the method of the first example, wherein the selected one of the connections is the Wi-Fi connection, the method further comprising, after activating the UE, accessing a network service associating multiple devices of a user of the UE with a singular account, retrieving a phone number from the network service, wherein the phone number is associated with one of the multiple devices of the user, initiating a transfer of the phone number from the one of the multiple devices to the UE and performing a setup of a cellular service for the UE based on at least the phone number.

In a ninth example, the method of the first example, wherein the selected one of the connections is the Wi-Fi connection, the method further comprising, after activating the UE, determining a carrier is tethered to the UE, wherein a user of the UE has a cellular service plan with the carrier, receiving identification information related to the cellular service plan from the user, verifying the identification information and, when the identification information is verified, performing a setup of a cellular service for the UE based on the cellular service plan.

In a tenth example, the method of the first example, wherein the selected one of the connections is the Wi-Fi connection, the method further comprising determining the UE cannot access a network service associating multiple devices of a user of the UE with a singular account, determining there is no carrier tethered to the UE, determining one or more options for a cellular setup of the UE, displaying the one or more options to a user of the UE, receiving a selection of the one or more options and performing a setup of a cellular service for the UE based on the selected one or more options.

In an eleventh example, the method of the first example, further comprising determining a phone number has been setup on the UE and performing a further setup of the UE, wherein the further setup does not include an option to transfer a phone number to the UE.

In a twelfth example, the method of the first example, wherein, when the selected one of the connections is the bootstrap connection, the method further comprising after activating the UE, accessing a discovery server based on first information determined when activating the UE, determining the discovery server includes multiple available phone numbers for the UE, displaying each of the available phone numbers to a user of the UE, receiving a selection of one of the available phone numbers and performing a setup of a cellular service for the UE based on second information retrieved from the discovery server corresponding to the selected one of the available phone numbers.

In a thirteenth example, a processor configured to perform any of the methods of the first through twelfth examples.

In a fourteenth example, a user equipment (UE) comprising a transceiver configured to communicate with a further device and a processor communicatively coupled to the transceiver and configured to perform any of the methods of the first through twelfth examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus of a user equipment (UE), the apparatus comprising processing circuitry configured to:
receive, via user input, a selection of one of a plurality of connections or a QR code to activate a user equipment (UE), wherein the plurality of connections comprise a Wi-Fi connection or a bootstrap connection to a further device; and
activate the UE using the selected one of the connections or QR code.

2. The apparatus of claim 1, wherein, when the selected one of the connections is the bootstrap connection, the processing circuitry is further configured to:
after activating the UE, determine the UE is a managed device or a store demo unit;
access a discovery server based on first information determined when activating the UE; and
perform a setup of a cellular service for the UE based on second information retrieved from the discovery server, wherein the setting up of the cellular service is performed without any input from a user of the UE.

3. The apparatus of claim 1, wherein the processing circuitry is further configured to:
after activating the UE, determine a phone number is tethered to the UE, wherein the phone number is related to a cellular service plan for a user of the UE;
receive, via user input, identification information related to the cellular service plan;
verify the identification information; and
when the identification information is verified, perform a setup of a cellular service for the UE based on the cellular service plan.

4. The apparatus of claim 1, wherein the processing circuitry is further configured to:
after activating the UE, determine a carrier is tethered to the UE, wherein a user of the UE has a cellular service plan with the carrier;
receive, via user input, identification information related to the cellular service plan;
verify the identification information; and
when the identification information is verified, perform a setup of a cellular service for the UE based on the cellular service plan.

5. The apparatus of claim 4, wherein the identification information is verified based on the processing circuitry being further configured to:
receive, via user input, a verification code, wherein the verification code is received in a short message service (SMS) message on the further device from the carrier.

6. The apparatus of claim 1, wherein the processing circuitry is further configured to:
after activating the UE, determine one or more options for a cellular setup of the UE;
displaying the one or more options to a user of the UE;
receive, via user input, a selection of the one or more options; and
perform a setup of a cellular service for the UE based on the selected one or more options.

7. The apparatus of claim 6, wherein the selected one of the options is for the cellular setup using a QR code, and wherein the setup of the cellular service is based on the processing circuitry being further configured to:
configure an optical scanning component of the UE to scan a QR code; and
retrieve information for the setup of the cellular service based on the QR code.

8. The apparatus of claim 1, wherein the selected one of the connections is the Wi-Fi connection, wherein the processing circuitry is further configured to:
after activating the UE, access a network service associating multiple devices of a user of the UE with a singular account;
retrieve a phone number from the network service, wherein the phone number is associated with one of the multiple devices of the user;
initiate a transfer of the phone number from the one of the multiple devices to the UE; and
perform a setup of a cellular service for the UE based on at least the phone number.

9. The apparatus of claim 1, wherein the selected one of the connections is the Wi-Fi connection, wherein the processing circuitry is further configured to:
after activating the UE, determine a carrier is tethered to the UE, wherein a user of the UE has a cellular service plan with the carrier;
receive, via user input, identification information related to the cellular service plan;
verify the identification information; and
when the identification information is verified, perform a setup of a cellular service for the UE based on the cellular service plan.

10. The apparatus of claim 1, wherein the selected one of the connections is the Wi-Fi connection, wherein the processing circuitry is further configured to:
determine the UE cannot access a network service associating multiple devices of a user of the UE with a singular account;
determine there is no carrier tethered to the UE;
determine one or more options for a cellular setup of the UE;
configure a display of the UE to display the one or more options to a user of the UE;
receiving, via user input, a selection of the one or more options; and
perform a setup of a cellular service for the UE based on the selected one or more options.

11. The apparatus of claim 1, wherein the processing circuitry is further configured to:
determine a phone number has been setup on the UE; and
perform a further setup of the UE, wherein the further setup does not include an option to transfer a phone number to the UE.

12. The apparatus of claim 1, wherein, when the selected one of the connections is the bootstrap connection, the processing circuitry is further configured to:
after activating the UE, access a discovery server based on first information determined when activating the UE;
determine the discovery server includes multiple available phone numbers for the UE;
configure a display of the UE to display each of the available phone numbers to a user of the UE;
receive, via user input, a selection of one of the available phone numbers; and
perform a setup of a cellular service for the UE based on second information retrieved from the discovery server corresponding to the selected one of the available phone numbers.

13. A processor of a user equipment (UE) comprising processing circuitry configured to:
receive, via user input, a selection of one of a plurality of connections or a QR code to activate a user equipment (UE), wherein the plurality of connections comprise a Wi-Fi connection or a bootstrap connection to a further device; and
activate the UE using the selected one of the connections or QR code.

14. The processor of claim 1, wherein, when the selected one of the connections is the bootstrap connection, the processing circuitry is further configured to:
after activating the UE, determine the UE is a managed device or a store demo unit;
access a discovery server based on first information determined when activating the UE; and
perform a setup of a cellular service for the UE based on second information retrieved from the discovery server, wherein the setting up of the cellular service is performed without any input from a user of the UE.

15. The processor of claim 13, wherein the processing circuitry is further configured to:
after activating the UE, determine one or more options for a cellular setup of the UE;
displaying the one or more options to a user of the UE;
receive, via user input, a selection of the one or more options; and
perform a setup of a cellular service for the UE based on the selected one or more options.

16. The processor of claim 15, wherein the selected one of the options is for the cellular setup using a QR code, and wherein the setup of the cellular service is based on the processing circuitry being further configured to:
configure an optical scanning component of the UE to scan a QR code; and
retrieve information for the setup of the cellular service based on the QR code.

17. The processor of claim 13, wherein the selected one of the connections is the Wi-Fi connection, wherein the processing circuitry is further configured to:
after activating the UE, access a network service associating multiple devices of a user of the UE with a singular account;
retrieve a phone number from the network service, wherein the phone number is associated with one of the multiple devices of the user;
initiate a transfer of the phone number from the one of the multiple devices to the UE; and
perform a setup of a cellular service for the UE based on at least the phone number.

18. The processor of claim 13, wherein the selected one of the connections is the Wi-Fi connection, wherein the processing circuitry is further configured to:
after activating the UE, determine a carrier is tethered to the UE, wherein a user of the UE has a cellular service plan with the carrier;
receive, via user input, identification information related to the cellular service plan;
verify the identification information; and
when the identification information is verified, perform a setup of a cellular service for the UE based on the cellular service plan.

19. The processor of claim 13, wherein the selected one of the connections is the Wi-Fi connection, wherein the processing circuitry is further configured to:
determine the UE cannot access a network service associating multiple devices of a user of the UE with a singular account;
determine there is no carrier tethered to the UE;
determine one or more options for a cellular setup of the UE;
configure a display of the UE to display the one or more options to a user of the UE;
receiving, via user input, a selection of the one or more options; and
perform a setup of a cellular service for the UE based on the selected one or more options.

20. The processor of claim 13, wherein, when the selected one of the connections is the bootstrap connection, the processing circuitry is further configured to:
after activating the UE, access a discovery server based on first information determined when activating the UE;
determine the discovery server includes multiple available phone numbers for the UE;
configure a display of the UE to display each of the available phone numbers to a user of the UE;
receive, via user input, a selection of one of the available phone numbers; and
perform a setup of a cellular service for the UE based on second information retrieved from the discovery server corresponding to the selected one of the available phone numbers.
